(19) United States
(12) Patent Application Publication
(10) Pub. No.: US 2021/0008993 A1
(43) Pub. Date: Jan. 14, 2021

(54) ELECTRIC-POWERED VEHICLE, CHARGING SYSTEM, AND CHARGING-DISCHARGING SYSTEM

(71) Applicant: Mitsubishi Electric Corporation, Tokyo (JP)

(72) Inventor: Yutaka KUBOYAMA, Tokyo (JP)

(73) Assignee: Mitsubishi Electric Corporation, Tokyo (JP)

(21) Appl. No.: 16/605,751

(22) PCT Filed: Dec. 4, 2018
(86) PCT No.: PCT/JP2018/044593

§ 371 Date: Oct. 16, 2019

(51) Int. Cl. B60L 53/18; B60L 53/16; B60L 53/62; B60L 58/15

(52) U.S. Cl. CPC B60L 53/18; B60L 58/15; B60L 53/62; B60L 53/16

(57) ABSTRACT

An electric-powered vehicle including a main battery, a system-control power supply, and an inlet electrically connected to the main battery, wherein the electric-powered vehicle is connected to a charger including a system-control power supply through a cable that is provided at one end with a connector connectable to the inlet, the electric-powered vehicle includes a voltage detector to detect that a voltage is applied to a charging permission-prohibition line by the system-control power supply, a relay to open/close an electric path between the system-control power supply and a connector-connection checking line, and a controller to control the relay, and when the controller detects from the voltage detector that a voltage is not applied to the charging permission-prohibition line by the system-control power supply, the controller causes the relay to open the electric path between the system-control power supply and the connector-connection checking line.

### FIELD

The present invention relates to an electric-powered vehicle including a main battery for vehicle driving, relates to a charging system that charges a main battery installed in an electric-powered vehicle, and relates to a charging-discharging system that charges/discharges the main battery.

### BACKGROUND

In recent years, as the number of electric-powered vehicles such as Electric Vehicles (EV) and Plug-in Hybrid Vehicles (PHV) increases, public charging facilities are coming into widespread use. PnC (Plug and Charge) has been proposed as a billing system for a battery-charge device for electric-powered vehicles, in which battery charge automatically starts upon solely connecting a connector of the battery-charge device to the vehicle.

A charging-discharging device for an electric-powered vehicle has started being employed as a V2H (Vehicle to Home) system or as a V2G (Vehicle to Grid) system. The V2H system uses a storage battery of the electric-powered vehicle for a household energy storage system that adjusts the amount of electric power to be sold and purchased. The V2G system uses a storage battery of the electric-powered vehicle for a Virtual Power Plant (VPP) that adjusts the utility-power supply and demand balance. In order to manage the quantity of storage batteries available, there has been a need for a device that checks for a vehicle connection state.

The interface and the sequence are defined so as to ensure interconnectivity between an electric-powered vehicle and a charger. For example, as defined in the specifications, an electric-powered vehicle and a charger include a charging start-stop unit and a communication unit, in which when a connector of the charger is connected to the electric-powered vehicle, a charging start-stop relay of the charger is turned on, and then the electric-powered vehicle and the charger start communicating with each other.

Patent Literature 1 proposes a connector connection checking unit that detects a connection state between a charger and an electric-powered vehicle by using a connector-connection checking line between the electric-powered vehicle and the charger.

### CITATION LIST

### Patent Literature

Patent Literature 1: Japanese Patent Application Laid-open No. 2014-217272

### SUMMARY

### Technical Problem

However, in the connector connection checking unit disclosed in Patent Literature 1, a voltage needs to be applied from the electric-powered vehicle to the connector-connection checking line. This leads to a problem that the connector connection checking unit cannot be applicable to, for example, an electric-powered vehicle in which a voltage is not applied to the connector-connection checking line due to concerns about a possible short circuit in the power supply, possible electrode corrosion, or possible discharge of an auxiliary battery.

The present invention has been achieved to solve the above problems, and an object of the present invention is to provide an electric-powered vehicle in which a charger can detect connection with the electric-powered vehicle without continuously applying a voltage to a connector-connection checking line.

### Solution to Problem

In order to solve the above problems and achieve the object, the present invention provides an electric-powered vehicle including a power supply for vehicle driving, a first system-control power supply, and an inlet electrically connected to the power supply for vehicle driving, wherein the electric-powered vehicle is connected to a charger or charger/discharger including a second system-control power supply through a cable that is provided at one end with a connector connectable to the inlet, the cable including a first signal line and a second signal line, the electric-powered vehicle includes a first voltage detector to detect that a voltage is applied to the second signal line by the second system-control power supply, a first relay to open/close an electric path between the first system-control power supply and the first signal line, and a vehicle controller to control the first relay. When the vehicle controller detects from the first voltage detector that a voltage is not applied to the second signal line by the second system-control power supply, the vehicle controller causes the first relay to open the electric path between the first system-control power supply and the first signal line.

### Advantageous Effects of Invention

According to the present invention, there is an effect where it is possible to obtain an electric-powered vehicle in which a charger can detect connection with the electric-powered vehicle without continuously applying a voltage to a connector-connection checking line.

### BRIEF DESCRIPTION OF DRAWINGS

FIG. 1 is a diagram illustrating a configuration of a charging system according to a first embodiment of the present invention.

FIG. 2 is a diagram illustrating a circuit of an interface section between an electric-powered vehicle and a charger according to the first embodiment.

FIG. 3 is a flowchart illustrating a sequence of applying a voltage to a connector-connection checking line by the electric-powered vehicle according to the first embodiment.

FIG. 4 is a diagram illustrating an operation of the electric-powered vehicle and the charger according to the first embodiment to detect a vehicle connection state.

FIG. 5 is a diagram illustrating a configuration of a charging system according to a second embodiment of the present invention.

FIG. 6 is a diagram illustrating a circuit of an interface section between an electric-powered vehicle and a charger according to the second embodiment.

FIG. 7 is a diagram illustrating a configuration of a connector in the charging system according to the second embodiment.

FIG. 8 is a flowchart illustrating a sequence of applying a voltage to a charging permission-prohibition line by the charger according to the second embodiment.

FIG. 9 is a diagram illustrating an operation of the electric-powered vehicle and the charger according to the second embodiment to detect a vehicle connection state.

FIG. 10 is a diagram illustrating a configuration in which functions of controllers in the charging system according to the first embodiment or the second embodiment are implemented by hardware.

FIG. 11 is a diagram illustrating a configuration in which functions of the controllers in the charging system according to the first embodiment or the second embodiment are implemented by software.

### DESCRIPTION OF EMBODIMENTS

An electric-powered vehicle, a charging system, and a charging-discharging system according to embodiments of the present invention will be described in detail below with reference to the accompanying drawings. The present invention is not limited to the embodiments.

### First Embodiment

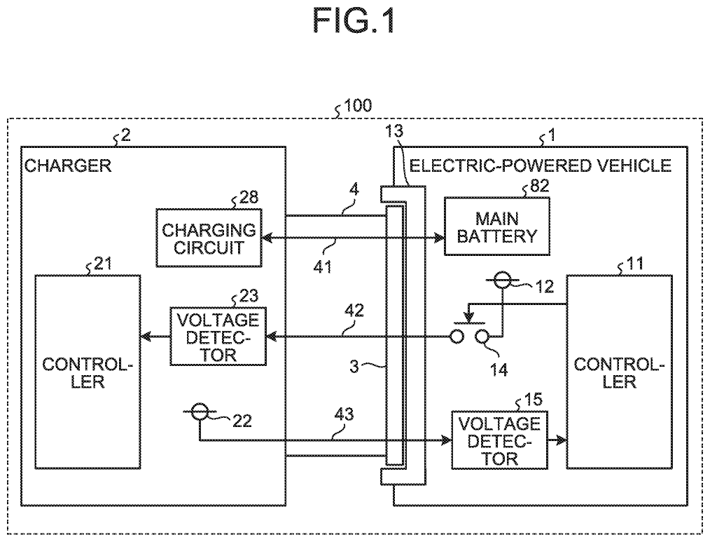

FIG. 1 is a diagram illustrating a configuration of a charging system according to a first embodiment of the present invention. A charging system 100 includes an electric-powered vehicle 1 and a charger 2. The electric-powered vehicle 1 includes a main battery 82 that is a storage battery serving as a power supply for vehicle driving, and an inlet 13 used for charging the main battery 82. The charger 2 includes a cable 4. The cable 4 is provided at one end thereof with a connector 3 connectable to the inlet 13. The cable 4 includes a power line 41, a connector-connection checking line 42 that is the first signal line, and a charging permission-prohibition line 43 that is the second signal line. The electric-powered vehicle 1 and the charger 2 are connected through the connector 3 and the inlet 13.

The electric-powered vehicle 1 further includes a controller 11 that is the vehicle controller, a system-control power supply 12 that is the first system-control power supply, a relay 14 that is the first relay, and a voltage detector 15 that is the first voltage detector. The controller 11 controls the relay 14 on the basis of a voltage value output from the voltage detector 15. The controller 11 communicates with a controller 21 in the charger 2 through the cable 4, and performs signal input and output with the controller 21 through the cable 4 to thereby manage the charging sequence of the electric-powered vehicle 1. The system-control power supply 12 supplies power from the electric-powered vehicle 1 to the charger 2. It is allowable that the system-control power supply 12 is a battery provided separately from the main battery 82, or a circuit that boosts or lowers the voltage of electric power of the battery and outputs the electric power. It is also allowable that the system-control power supply 12 is a circuit that lowers the voltage of electric power of the main battery 82 and outputs the electric power. The relay 14 opens/closes the electric path between the system-control power supply 12 and the connector-connection checking line 42. The voltage detector 15 detects a voltage between the charging permission-prohibition line 43 and a frame ground FG2.

The charger 2 further includes the controller 21 that is the charger controller, a system-control power supply 22 that is the second system-control power supply, a charging circuit 28, and a voltage detector 23 that is the second voltage detector. The controller 21 detects a connection state of the electric-powered vehicle 1 on the basis of a voltage value output from the voltage detector 23. The controller 21 communicates with the controller 11 through the cable 4, and performs signal input and output with the controller 11 through the cable 4 to thereby manage the charging sequence of the charger 2. The system-control power supply 22 supplies electric power from the charger 2 to the electric-powered vehicle 1 to be used as a power supply for the electric-powered vehicle 1. The voltage detector 23 detects a voltage between the connector-connection checking line 42 and a frame ground FG1. The charging circuit 28 converts electric power input from a utility power supply to electric power suitable for charging the main battery 82, and outputs the converted electric power.

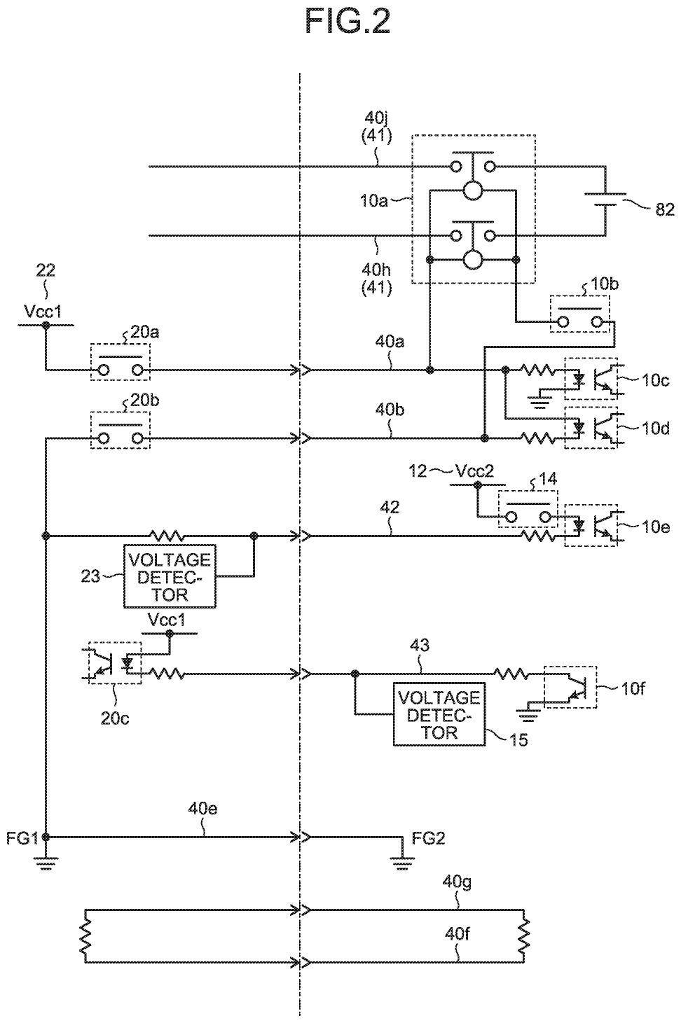

FIG. 2 is a diagram illustrating a circuit of the interface section between the electric-powered vehicle and the charger according to the first embodiment. FIG. 2 illustrates, on the left side with respect to the dot-and-dash line, a circuit provided in the charger 2 and the connector 3. FIG. 2 illustrates, on the right side with respect to the dot-and-dash line, a circuit provided in the electric-powered vehicle 1.

The cable 4 includes a first charging start-stop line 40a, a second charging start-stop line 40b, the connector-connection checking line 42, the charging permission-prohibition line 43, a ground line 40e, a first communication line 40f, a second communication line 40g, a first power line 40h, and a second power line 40j. In the electric-powered vehicle 1 and the charger 2, the ground line 40e is connected to the frame ground FG1 and the frame ground FG2. The first power line 40h and the second power line 40j are equivalent to the power line 41 in FIG. 1. As an example of the first communication line 40f and the second communication line 40g, a CAN (Control Area Network) bus communication lines such as CAN-H and CAN-L can be illustrated. However, the first communication line 40f and the second communication line 40g are not limited to this example.

A charging start relay 20a is applied at one end with a voltage Vcc1 of the system-control power supply 22. The other end of the charging start relay 20a is connected to one end of the first charging start-stop line 40a. The other end of the first charging start-stop line 40a is connected to an anode of a diode located on the primary side of a photocoupler 10c that is a relay detector through a resistance. A cathode of the diode is grounded.

The first charging start-stop line 40a is also connected to two solenoids that respectively drive two switches constituting a vehicle contactor 10a. The other end of the first charging start-stop line 40a is also connected to an anode of a diode located on the primary side of a photocoupler 10d that is a relay detector.

Each of the two solenoids described above is connected to one end of a vehicle contactor drive relay 10b. The other end of the vehicle contactor drive relay 10b is connected to the second charging start-stop line 40b, and is thus connected to a cathode of the diode located on the primary side of the photocoupler 10d through a resistance.

The other end of the second charging start-stop line 40b is connected to one end of the charging start relay 20b. The other end of the charging start relay 20b is connected to the frame ground FG1 on the side of the charger 2, is connected to one end of the connector-connection checking line 42, and is connected to one end of the ground line 40e.

The other end of the connector-connection checking line 42 is connected to a cathode of a diode located on the primary side of a photocoupler 10e that is a connection detector through a resistance. One end of the relay 14 is connected to an anode of the above diode. The other end of the relay 14 is applied with a voltage Vcc2 of the system-control power supply 12.

The other end of the ground line 40e is connected to a negative electrode of the system-control power supply 12, and is also connected to the frame ground FG2 on the side of the electric-powered vehicle 1.

One end of the charging permission-prohibition line 43 is connected to a collector of a transistor 10f that is a charging permission-prohibition output unit. An emitter of the transistor 10f is grounded. The other end of the charging permission-prohibition line 43 is connected to a cathode of a diode located on the primary side of a photocoupler 20c that is a charging permission-prohibition input unit through a resistance. An anode of the above diode is applied with the voltage Vcc1 of the system-control power supply 22.

On the basis of a charging-related signal, the transistor 10f causes a current to flow to the diode on the primary side of the photocoupler 20c, or stops the current flow to the diode. Due to this operation, the transistor 10f controls permission for charging the electric-powered vehicle 1. The photocoupler 20c transmits a signal indicating that charging is permitted or prohibited from the electric-powered vehicle 1 to the controller 21.

The vehicle contactor 10a is closed by closing the charging start relays 20a and 20b on the side of the charger 2, and by closing the vehicle contactor drive relay 10b on the side of the electric-powered vehicle 1. Due to this operation, the main battery 82 is connected to the first power line 40h and the second power line 40j, and is thus brought into a chargeable state.

The photocoupler 10e is intended to check for connection of the connector 3. When the connector 3 is connected to the inlet 13, and when the relay 14 is in a closed state, a current flows to the frame ground FG2 through the diode on the primary side of the photocoupler 10e, the connector-connection checking line 42, the frame ground FG1 on the side of the charger 2, and the ground line 40e. Due to this current flow, the diode on the primary side of the photocoupler 10e emits light, and information is transmitted to the controller 21 which indicates that the connector 3 has been connected to the inlet 13.

The photocoupler 10c and the photocoupler 10d transmit a signal indicating the start of charging from the charger 2 to the controller 11.

The first communication line 40f and the second communication line 40g are used for data transmission between the controller 11 and the controller 21.

The relay 14 and the voltage detector 15 are necessary hardware to be added to an ordinary electric-powered vehicle in order to constitute the electric-powered vehicle 1. Even for an ordinary electric-powered vehicle, it is still necessary to instantaneously stop charging when the ground line 40e is broken. In order to prevent charging from being continued by a sneak-path current that may flow from the connector-connection checking line 42 to the charging permission-prohibition line 43, an ordinary electric-powered vehicle is required to include a sneak-path current prevention circuit equivalent to the relay 14. Therefore, in a case where an electric-powered vehicle that is the base of the electric-powered vehicle 1 satisfies this requirement, solely adding the voltage detector 15 to this base electric-powered vehicle can constitute the electric-powered vehicle 1.

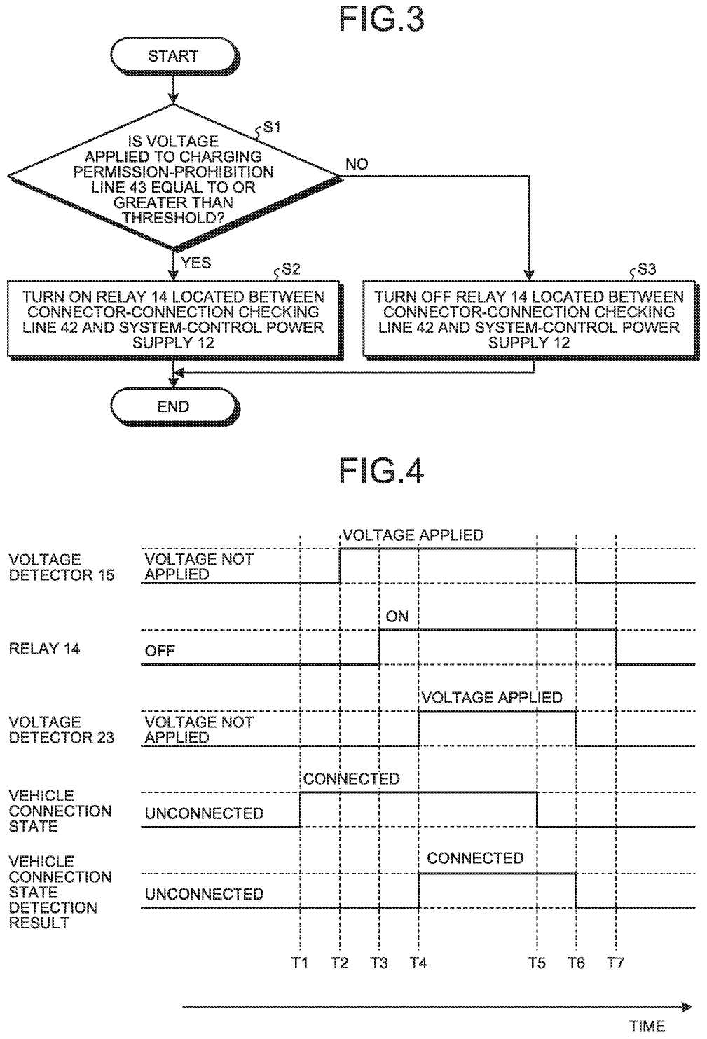

FIG. 3 is a flowchart illustrating a sequence of applying a voltage to the connector-connection checking line by the electric-powered vehicle according to the first embodiment. First, at Step S1, the controller 11 detects a voltage applied to the charging permission-prohibition line 43 by using the voltage detector 15, and determines whether the voltage applied to the charging permission-prohibition line 43 is equal to or greater than a threshold. When the connector 3 is connected to the inlet 13, a voltage of the system-control power supply 22 is applied to the charging permission-prohibition line 43.

When the voltage applied to the charging permission-prohibition line 43 is equal to or greater than a threshold, the determination is YES at Step S1. At Step S2, the controller 11 turns the relay 14 on. As the relay 14 is turned on, a voltage of the system-control power supply 12 is applied to the connector-connection checking line 42.

When the voltage applied to the charging permission-prohibition line 43 is not equal to or greater than a threshold, the determination is NO at Step S1. At Step S3, the controller 11 turns the relay 14 off. As the relay 14 is turned off, a voltage of the system-control power supply 12 is not applied to the connector-connection checking line 42.

In the sequence in FIG. 3 described above, when the connector 3 is not connected to the inlet 13, a voltage of the system-control power supply 12 is not applied to the connector-connection checking line 42. Due to this operation, the charging system 100 according to the first embodiment can reduce the risk of occurrence of phenomena such as a short circuit in the power supply of the electric-powered vehicle 1, electrode corrosion, and discharge of an auxiliary battery.

FIG. 4 is a diagram illustrating an operation of the electric-powered vehicle and the charger according to the first embodiment to detect a vehicle connection state. When the connector 3 is connected to the inlet 13 at a time T1, the controller 11 detects that a voltage is applied to the charging permission-prohibition line 43 at a time T2 on the basis of an output of the voltage detector 15. At a time T3, the controller 11 turns the relay 14 on.

When the controller 11 turns the relay 14 on, the controller 21 detects that a voltage is applied to the connector-connection checking line 42 at a time T4 on the basis of an output of the voltage detector 23, and detects a connected state of the vehicle. At this time, the charger 2 automatically starts charging so that a device that automatically starts charging by solely connecting the connector 3 to the inlet 13 can be obtained. That is, the PnC can be achieved in which charging automatically starts by solely connecting the connector 3 to the inlet 13.

At a time T5, the connector 3 is removed from the inlet 13. At a time T6, the controller 21 detects that a voltage is not applied to the connector-connection checking line 42 on the basis of an output of the voltage detector 23, and detects an unconnected state of the vehicle. The controller 11 detects that a voltage is not applied to the charging permission-prohibition line 43 on the basis of an output of the voltage detector 15, and turns the relay 14 off at a time T7.

As described above, in the charging system 100 according to the first embodiment, even when the connector 3 is not connected to the electric-powered vehicle 1, the charger 2 can still detect a connection state of the electric-powered vehicle 1 without applying a voltage of the system-control power supply 12 to the connector-connection checking line 42.

Further, by solely adding the relay 14 and the voltage detector 15 to an electric-powered vehicle, the charging system 100 according to the first embodiment can reduce the risk of occurrence of phenomena such as a short circuit in the power supply of the electric-powered vehicle 1, electrode corrosion, and discharge of an auxiliary battery, and can improve the quality of the charging system 100, while suppressing an increase in costs of the electric-powered vehicle 1 and the charger 2.

### Second Embodiment

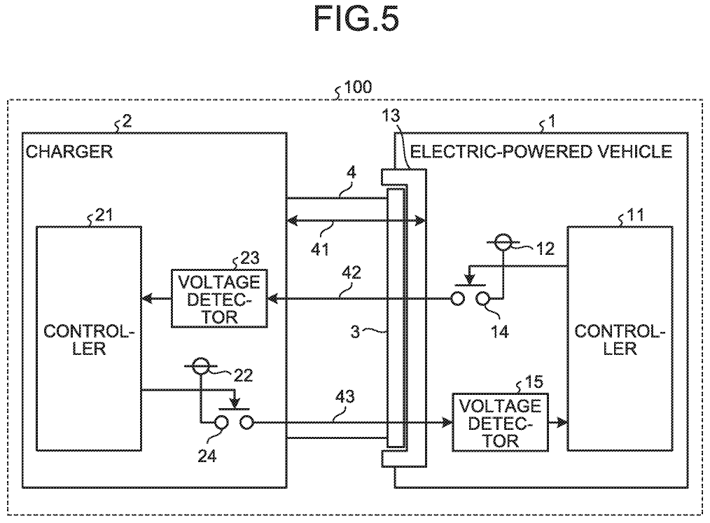

FIG. 5 is a diagram illustrating a configuration of a charging system according to a second embodiment of the present invention. In the following descriptions, only elements different from those of the charging system 100 according to the first embodiment are described, and descriptions of elements common to those of the charging system 100 according to the first embodiment are omitted.

The charger 2 includes the controller 21, the system-control power supply 22, the voltage detector 23, and a relay 24. The relay 24 that is the second relay opens/closes the electric path between the system-control power supply 22 and the charging permission-prohibition line 43. The controller 21 controls the relay 24, receives an output of the voltage detector 23, and detects a connection state of the electric-powered vehicle 1. The controller 21 communicates with the controller 11 through the cable 4, and performs signal input and output with the controller 11 through the cable 4 to thereby manage the charging sequence of the charger 2. The voltage detector 23 detects a voltage of the connector-connection checking line 42.

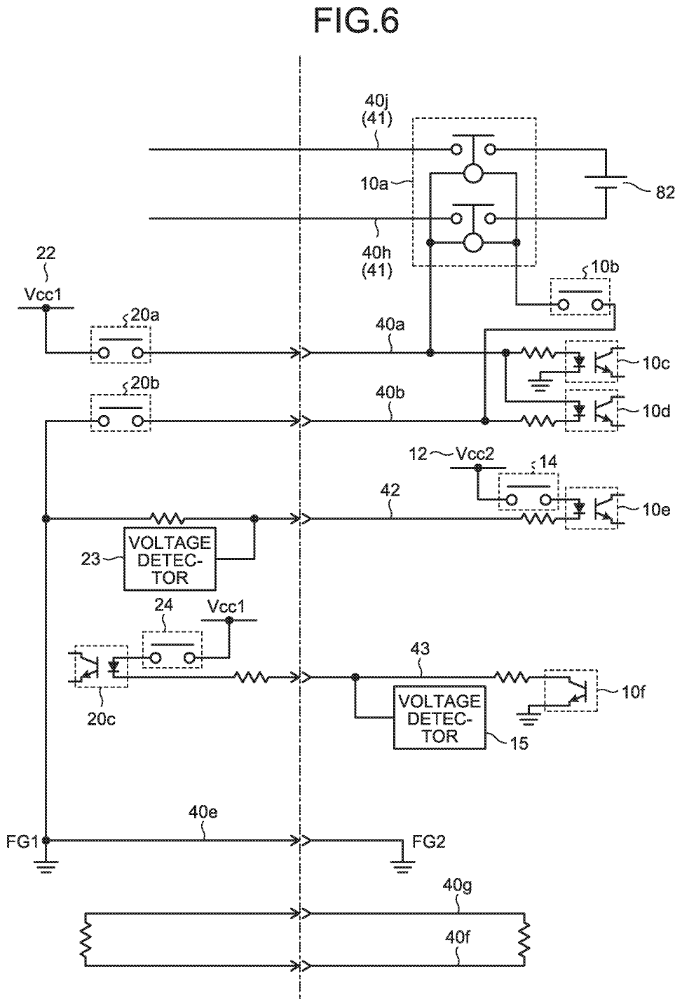

FIG. 6 is a diagram illustrating a circuit of the interface section between the electric-powered vehicle and the charger according to the second embodiment. Differences from the charging system 100 according to the first embodiment are described below.

The charger 2 includes the relay 24 in addition to the charging start relays 20a and 20b, the photocoupler 20c that is the charging permission-prohibition input unit, the system-control power supply 22, and the voltage detector 23. The relay 24 is located between the photocoupler 20c and the system-control power supply 22. That is, the relay 24 is located between the charging permission-prohibition input unit and the system-control power supply 22.

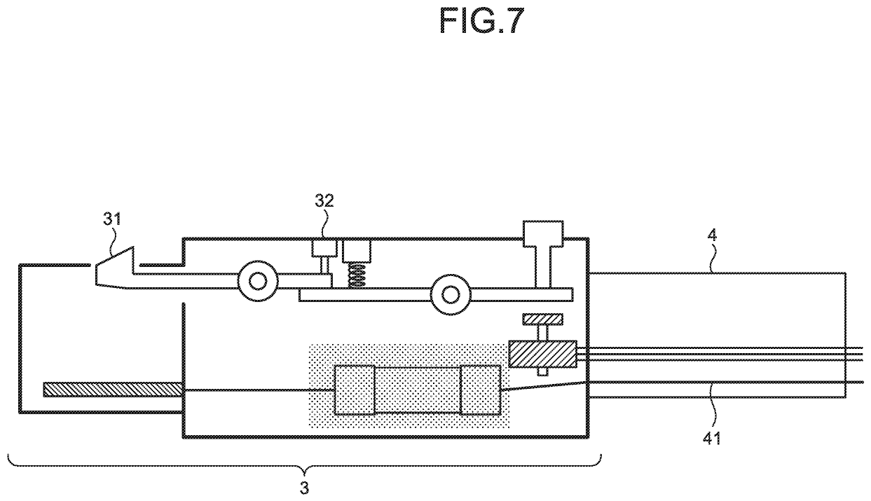

FIG. 7 is a diagram illustrating a configuration of the connector in the charging system according to the second embodiment. The connector 3 includes a latch 31 that mates with the inlet 13, and a latch state detector 32 that detects a state of the latch 31. The latch state detector 32 detects a latched state in which the latch 31 protrudes from the connector 3, or an unlatched state in which the latch 31 retracts into the connector 3. When the connector 3 is being inserted into the inlet 13, the latch 31 is tentatively brought into the unlatched state. When the connector 3 is properly inserted into the inlet 13, the latch 31 is brought back into to the latched state.

The latch state detector 32 is necessary hardware to be added to an ordinary charger in order to constitute the charger 2. Even an ordinary charger is still required to include a unit that detects a latch state of the connector. In general, the existing connectors have the latch state detector 32 installed therein. A charger, which satisfies this requirement, can constitute the charger 2 without additional hardware.

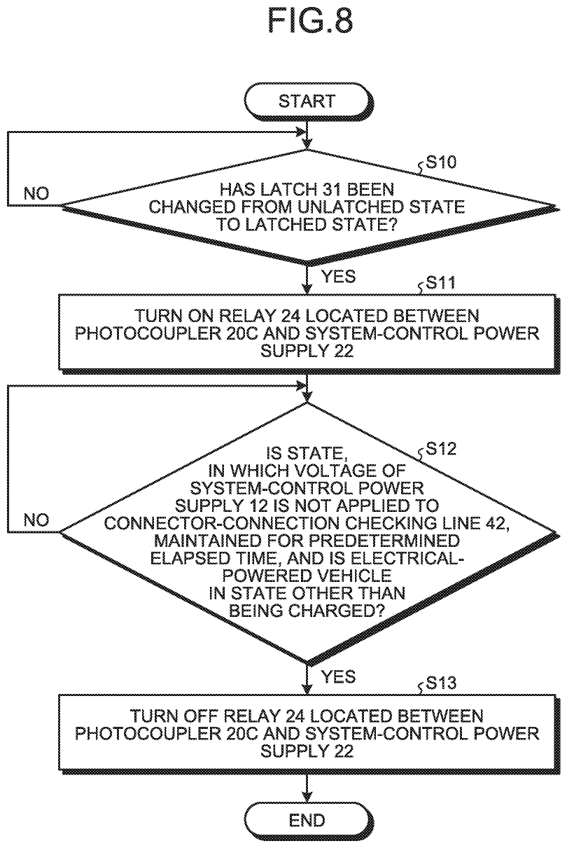

FIG. 8 is a flowchart illustrating a sequence of applying a voltage to the charging permission-prohibition line by the charger according to the second embodiment. At Step S10, the controller 21 determines whether the latch 31 has been changed from the unlatched state to the latched state on the basis of a signal output from the latch state detector 32. In the process of connecting the connector 3 to the inlet 13, the latch 31 is tentatively changed from the latched state to the unlatched state. When the connector 3 is properly connected to the inlet 13, the latch 31 is changed from the unlatched state to the latched state.

When the latch 31 is changed from the unlatched state to the latched state, the determination is YES at Step S10. At Step S11, the controller 21 turns on the relay 24 located between the photocoupler 20c that is the charging permission-prohibition input unit and the system-control power supply 22. As the relay 24 is turned on, a voltage of the system-control power supply 22 is applied to the charging permission-prohibition line 43. When the latch 31 is not changed from the unlatched state to the latched state, the determination is NO at Step S10. The process flow returns to Step S10.

When a voltage of the system-control power supply 22 is applied to the charging permission-prohibition line 43, the controller 11 turns the relay 14 on in accordance with the sequence illustrated in FIG. 3 to apply a voltage of the system-control power supply 12 to the connector-connection checking line 42.

At Step S12, the controller 21 detects a voltage applied to the connector-connection checking line 42 on the basis of an output of the voltage detector 23, and then determines whether a state, in which the voltage of the system-control power supply 12 is not applied to the connector-connection checking line 42, is maintained for a predetermined elapsed time, and whether the electrical-powered vehicle 1 is in a state other than being charged.

When a state, in which the voltage of the system-control power supply 12 is not applied to the connector-connection checking line 42, is maintained for a predetermined elapsed time, and when the electric-powered vehicle 1 is in a state other than being charged, then the determination is YES at Step S12. At Step S13, the controller 21 turns the relay 24 off. As the relay 24 is turned off, a voltage of the system-control power supply 22 is not applied to the charging permission-prohibition line 43. When at least one of the conditions fails to be satisfied, the determination is NO at Step S12. One of the conditions is that a state, in which the voltage of the system-control power supply 12 is not applied to the connector-connection checking line 42, is maintained for a predetermined elapsed time. The other condition is that the electric-powered vehicle 1 is in a state other than being charged. The process flow returns to Step S12.

Even in an ordinary electric-powered vehicle, if a ground line is broken, a sneak-path current prevention circuit equivalent to the relay 14 in the electric-powered vehicle 1 according to the second embodiment may prevent a voltage of the system-control power supply from being applied to the connector-connection checking line during charging in order to prevent a sneak-path current from flowing from the connector-connection checking line to the charging permission-prohibition line. Therefore, it is allowable that the charger 2 according to the second embodiment masks the determination of whether the voltage applied to the connector-connection checking line 42 is equal to or greater than a threshold during charging.

In the sequence in FIG. 8 described above, when the connector 3 is not connected to the inlet 13, a voltage of the system-control power supply 22 is not applied to the connector-connection checking line 42. This can reduce the risk of occurrence of phenomena such as a short circuit in the system-control power supply 22 and electrode corrosion.

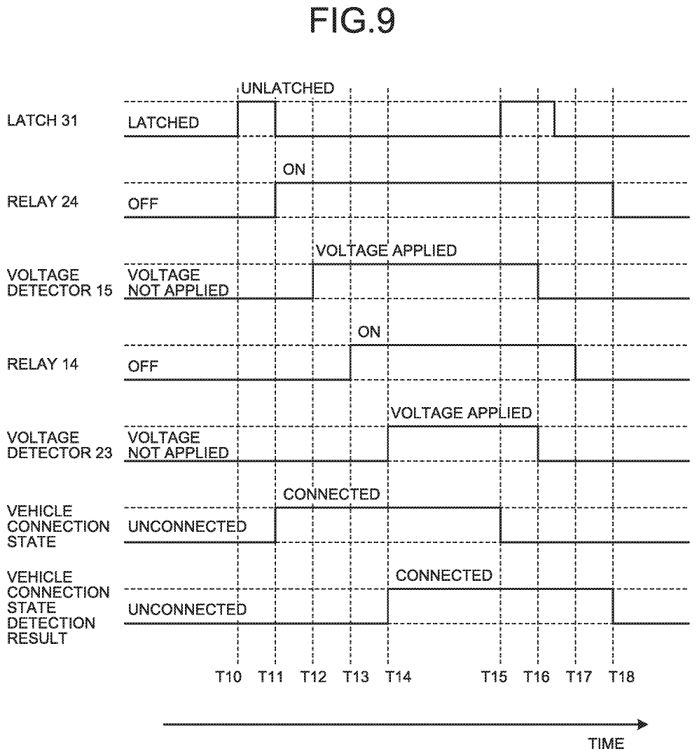

FIG. 9 is a diagram illustrating an operation of the electric-powered vehicle and the charger according to the second embodiment to detect a vehicle connection state. When the connector 3 starts being connected to the inlet 13 at a time T10, the latch 31 is changed from the latched state to the unlatched state. When the connector 3 has completed to be inserted into the inlet 13 at a time T11, the latch state detector 32 detects that the latch 31 has been changed from the unlatched state to the latched state. Because the latch state detector 32 detects that the latch 31 has been changed from the unlatched state to the latched state, the controller 21 turns on the relay 24 located between the charging permission-prohibition input unit and the system-control power supply 22.

At a time T12, the controller 21 detects that a voltage is applied to the charging permission-prohibition line 43 on the basis of an output of the voltage detector 15. At a time T13, the controller 11 turns on the relay 14 located between the connector-connection checking line 42 and the system-control power supply 12.

At a time T14, the controller 21 detects that a voltage is applied to the connector-connection checking line 42 on the basis of an output of the voltage detector 23, and detects a connected state of the vehicle. At this time, the charger 2 automatically starts charging so that a device that automatically starts charging by solely connecting the connector 3 to the inlet 13 can be obtained. That is, the PnC can be achieved in which charging automatically starts by solely connecting the connector 3 to the inlet 13.

At a time T15, the connector 3 is removed from the inlet 13. At a time T16, the controller 11 detects that a voltage is not applied to the charging permission-prohibition line 43 on the basis of an output of the voltage detector 15. Because the controller 11 detects that a voltage is not applied to the charging permission-prohibition line 43, the controller 11 turns off the relay 14 located between the connector-connection checking line 42 and the system-control power supply 12 at a time T17.

As the connector 3 is removed from the inlet 13 at the time T15, the controller 21 detects that a voltage is not applied to the connector-connection checking line 42 at the time T16 on the basis of an output of the voltage detector 23. Because the controller 21 detects that a voltage is not applied to the connector-connection checking line 42, the controller 21 detects an unconnected state of the vehicle after a lapse of a predetermined time, that is, at a time T18, and turns off the relay 24 located between the charging permission-prohibition input unit and the system-control power supply 22.

As described above, the charging system 100 according to the second embodiment can obtain a connector connection checking unit for the charger 2 to detect a connection state of the electric-powered vehicle 1 without applying a voltage of the system-control power supply 22 to the charging permission-prohibition line 43 when the connector 3 is not connected to the electric-powered vehicle 1, and can also obtain a device that automatically starts charging by solely connecting the connector 3 to the electric-powered vehicle 1.

Further, by solely adding the relay 24 to the charger 2, the charging system 100 according to the second embodiment can reduce the risk of occurrence of phenomena such as a short circuit in the system-control power supply 22 and electrode corrosion, and can improve the quality of the charging system 100, while suppressing an increase in costs of the electric-powered vehicle 1 and the charger 2.

It is allowable that the main battery 82 according to the first embodiment or the second embodiment described above is a fuel cell. That is, it is allowable that the electric-powered vehicle 1 is a Fuel Cell Vehicle (FCV). In a case where the electric-powered vehicle 1 is an FCV, the electric-powered vehicle 1 is connected to a charger/discharger that includes the system-control power supply 22 through the cable 4. The cable 4 is provided at one end with the connector 3 connectable to the inlet 13. The cable 4 also includes the connector-connection checking line 42 and the charging permission-prohibition line 43.

The functions of the controllers 11 and 21 in the charging system 100 according to the first embodiment or the second embodiment described above are implemented by a processing circuit. It is possible that the processing circuit is either dedicated hardware or a processing device that executes programs stored in a storage device.

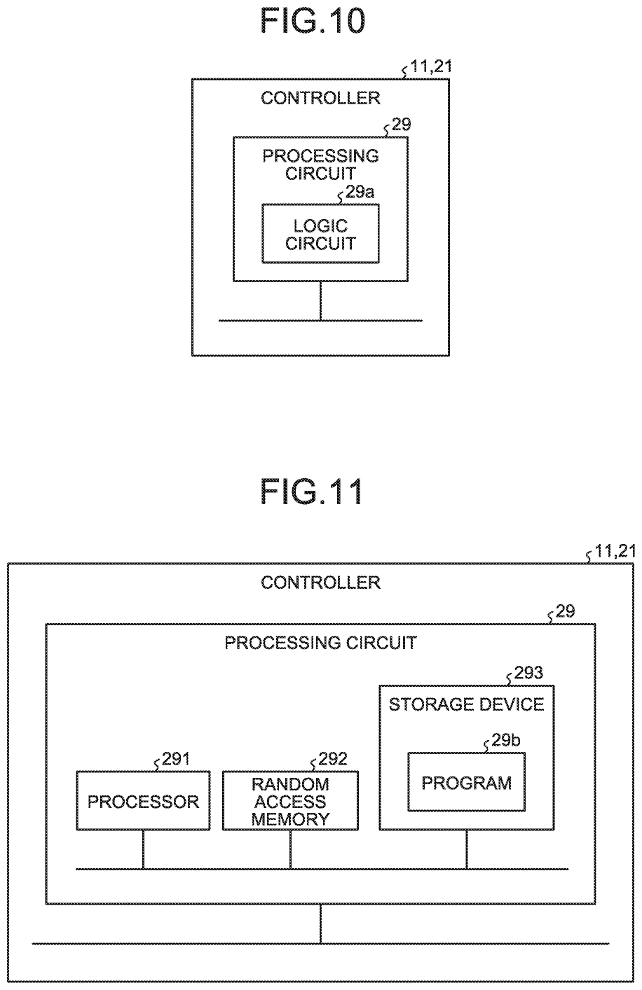

In a case where the processing circuit is dedicated hardware, the processing circuit corresponds to any of a single circuit, a combined circuit, a programmed processor, a parallel-programmed processor, an application specific integrated circuit, a field programmable gate array, and a combination thereof. FIG. 10 is a diagram illustrating a configuration in which the functions of the controllers in the charging system according to the first embodiment or the second embodiment are implemented by hardware. A processing circuit 29 has a logic circuit 29a incorporated therein. The logic circuit 29a implements the functions of the controllers 11 and 21.

In a case where the processing circuit 29 is a processing device, the functions of the controllers 11 and 21 are implemented by software, firmware, or a combination of software and firmware.

FIG. 11 is a diagram illustrating a configuration in which the functions of the controllers in the charging system according to the first embodiment or the second embodiment are implemented by software. The processing circuit 29 includes a processor 291 that executes a program 29b, a random access memory 292 to be used as a work area by the processor 291, and a storage device 293 that stores therein the program 29b. The processor 291 develops the program 29b, stored in the storage device 293, in the random access memory 292 and executes the program 29b to thereby implement the functions of the controllers 11 and 21. The software or firmware is described in a program language and stored in the storage device 293. While a central processing unit can be exemplified as the processor 291, the processor 291 is not limited thereto. A semiconductor memory such as a RAM (Random Access Memory), a ROM (Read Only Memory), a flash memory, an EPROM (Erasable Programmable Read Only Memory), or an EEPROM® (Electrically Erasable Programmable Read Only Memory) can be applied as the storage device 293. The semiconductor memory can be a non-volatile memory or a volatile memory. Further, other than a semiconductor memory, a magnetic disk, a flexible disk, an optical disk, a compact disc, a MiniDisk, or a DVD (Digital Versatile Disc) can be applied as the storage device 293. It is allowable that the processor 291 outputs data including computation results to the storage device 293 and stores the data in the storage device 293. It is also allowable that the processor 291 stores this data in an auxiliary storage device (not illustrated) through the random access memory 292.

The processing circuit 29 reads and executes the program 29b stored in the storage device 293 to thereby implement the functions of the controllers 11 and 21. The program 29b is also regarded as causing a computer to execute the procedure and method for implementing the functions of the controllers 11 and 21.

It is also possible for the processing circuit 29 to partially implement the functions of the controllers 11 and 21 by dedicated hardware, while partially implementing the functions of the controllers 11 and 21 by software or firmware.

In this manner, the processing circuit 29 can implement the respective functions described above by hardware, software, firmware, or a combination of these elements.

In the first and second embodiments described above, the charging system 100 that includes the charger 2 has been explained. However, the present invention is not limited thereto. In the present invention, the charger 2 may be replaced with a charger/discharger which may be applied to a charging-discharging system. The V2H system or the V2G system is also required to include a device that checks for a connection state of an electric-powered vehicle in order to manage the quantity of storage batteries available. In a case where the present invention is applied to the charging-discharging system, a controller in the V2H system or the V2G system obtains a connection state of the electric-powered vehicle 1 from a charging-discharging device, and thus can use the obtained connection state for managing the quantity of storage batteries available. This helps improve the stability of the system.

In the first and second embodiments described above, the voltage detectors 15 and 23 are used to determine whether a voltage is applied to the connector-connection checking line 42 or the charging permission-prohibition line 43. However, it is also possible to use a photocoupler or a relay. Further, the relays 14 and 24 are used in order not to apply a voltage to the connector-connection checking line 42 or the charging permission-prohibition line 43. However, it is also possible to use a semiconductor switch or the like.

In the first and second embodiments described above, the connector-connection checking line 42 is used for the charger 2 to detect a connection state of the electric-powered vehicle 1. It is also possible to use another signal line to be applied with a voltage of the system-control power supply 12. Further, the charging permission-prohibition line 43 is used for the electric-powered vehicle 1 to detect a connection state of the charger 2. It is also possible to use another signal line to be applied with a voltage of the system-control power supply 22.

The configurations described in the above embodiments are only examples of the content of the present invention. The configurations can be combined with other well-known techniques, and part of each of the configurations can be omitted or modified without departing from the scope of the present invention.

### REFERENCE SIGNS LIST

1 electric-powered vehicle, 2 charger, 3 connector, 4 cable, 10a vehicle contactor, 10b vehicle contactor drive relay, 10c, 10d, 10e, 20c photocoupler, 10f transistor, 11, 21 controller, 12, 22 system-control power supply, 13 inlet, 14, 24 relay, 15, 23 voltage detector, 20a, 20b charging start relay, 28 charging circuit, 29 processing circuit, 29a logic circuit, 29b program, 31 latch, 32 latch state detector, 40a first charging start-stop line, 40b second charging start-stop line, 40e ground line, 40f first communication line, 40g second communication line, 40h first power line, 40j second power line, 41 power line, 42 connector-connection checking line, 43 charging permission-prohibition line, 82 main battery, 100 charging system, 291 processor, 292 random access memory, 293 storage device.

1. An electric-powered vehicle including a power supply for vehicle driving, a first system-control power supply, and an inlet electrically connected to the power supply for vehicle driving, wherein
the electric-powered vehicle is connected to a charger or charger/discharger including a second system-control power supply through a cable that is provided at one end with a connector connectable to the inlet, the cable including a first signal line and a second signal line,
the electric-powered vehicle comprises: a first voltage detecting circuit to detect that a voltage is applied to the second signal line by the second system-control power supply; a first relay to open/close an electric path between the first system-control power supply and the first signal line; and a vehicle controlling circuit to control the first relay, and
when the vehicle controlling circuit detects from the first voltage detecting circuit that a voltage is not applied to the second signal line by the second system-control power supply, the vehicle controlling circuit causes the first relay to open the electric path between the first system-control power supply and the first signal line.

2. The electric-powered vehicle according to claim 1, wherein when the vehicle controlling circuit detects from the first voltage detecting circuit that a voltage is applied to the second signal line by the second system-control power supply, the vehicle controlling circuit causes the first relay to close the electric path between the first system-control power supply and the first signal line.

3. A charging system comprising:
the electric-powered vehicle according to claim 1; and
a charger including a second system-control power supply and a cable that is provided at one end with a connector connectable to the inlet, the cable including a first signal line and a second signal line, wherein
the inlet is used for charging the power supply for vehicle driving,
the charger includes
a second voltage detecting circuit to detect that a voltage is applied to the first signal line by the first system-control power supply,
a charger controlling circuit to detect that a voltage is applied to the first signal line by the first system-control power supply, and
a second relay to open/close an electric path between the second system-control power supply and the second signal line, and
when the charger controlling circuit detects from the second voltage detecting circuit that a voltage is not applied to the first signal line by the first system-control power supply, the charger controlling circuit causes the second relay to open the electric path between the second system-control power supply and the second signal line.

4. The charging system according to claim 3, wherein when the charger controlling circuit detects from the second voltage detecting circuit that a voltage is applied to the first signal line by the first system-control power supply, the charger controlling circuit causes the second relay to close the electric path between the second system-control power supply and the second signal line.

5. The charging system according to claim 3, wherein
the connector includes a latch to mate with the inlet, and a latch state detecting circuit to detect whether the latch is in a latched state in which the latch protrudes from the connector or in an unlatched state in which the latch retracts into the connector, and
the charger controlling circuit controls the second relay on a basis of a signal output from the latch state detecting circuit.

6. The charging system according to claim 3, wherein the charger controlling circuit detects from the second voltage detecting circuit that a voltage is applied to the first signal line by the first system-control power supply, and thus detects a connection state between the electric-powered vehicle and the charger.

7. The charging system according to claim 3, wherein when the charger controlling circuit detects from the second voltage detecting circuit that a voltage is applied to the first signal line by the first system-control power supply, the power supply for vehicle driving starts being charged.

8. A charging-discharging system including the charging system according to claim 3, wherein
the inlet is also used for feeding power from the power supply for vehicle driving, and
the charger includes a power feed function of drawing electric power of the power supply for vehicle driving through the cable and outputting the electric power to outside.
